(19) United States
(12) Patent Application Publication
(10) Pub. No.: US 2026/0247326 A1
(43) Pub. Date: Aug. 20, 2026

(54) METHOD AND APPARATUS FOR USER EQUIPMENT POSITIONING USING FREQUENCY HOPPING REFERENCE SIGNALS

(71) Applicant: Telefonaktiebolaget LM Ericsson (publ), Stockholm (SE)

(72) Inventors: Zhilan XIONG, Solna (SE); Johan BERGMAN, Stockholm (SE); Magnus LARSSON, Sollentuna (SE)

(21) Appl. No.: 18/997,344

(22) PCT Filed: Aug. 7, 2023
(86) PCT No.: PCT/CN2023/111431

§ 371 Date: Jan. 21, 2025

Related U.S. Application Data
(60) Provisional application No. 63/370,986, filed on Aug. 10, 2022.

(51) Int. Cl. H04W 64/00; H04L 5/00

(52) U.S. Cl. CPC H04W 64/00; H04L 5/0012; H04L 5/0051

(57) ABSTRACT

Various embodiments of the present disclosure provide a method for user equipment (UE) positioning. The method which may be performed by a UE includes: receiving a capability request message requesting information regarding the UE's positioning capabilities. In accordance with an exemplary embodiment, the method further includes: transmitting a response message responsive to the capability request message. The response message includes one or more of: frequency hopping capability information regarding the UE's frequency hopping capability with respect to new radio downlink time difference of arrival (NR DL-TDOA) positioning; frequency hopping capability information regarding the UE's frequency hopping capability with respect to NR uplink TDOA (NR UL-TDOA) positioning; and frequency hopping capability information regarding the UE's frequency hopping capability with respect to NR round-trip-time (NR RTT) positioning.

### FIELD OF THE INVENTION

The present disclosure relates generally to communications, and more particularly to the positioning of user equipments (UEs) using a frequency hopping reference signal.

### BACKGROUND

Many techniques can be used to determine the position of a UE. Such techniques include: the use of Assisted Global Navigation Satellite Systems, time difference of arrival (TDOA), round-trip-time (RTT), enhanced cell identifier, etc.

There are two types of TDOA: downlink TDOA (DL-TDOA) and uplink TDOA (UL-TDOA). Downlink (DL) refers to the transmission of a signal from a base station to a UE, while uplink (UL) refers to the transmission of a signal from the UE to the base station.

In DL-TDOA, a base station transmits a positioning reference signal (PRS) and the UE measures the PRS and sends a measurement report, which is then used to determine the UE's position. In UL-TDOA, the UE transmits a sounding reference signal (SRS) and the base station measures the SRS.

With the rapid development of networking and communication technologies, communication networks are expected to support services across a wide variety of industries and meet the diverse requirements of the services, e.g., providing positioning services for various UEs. Considering the diversity of UE capabilities and network deployments, configuration and implementation of UE positioning may become more challenging.

### SUMMARY

This summary is provided to introduce a selection of concepts in a simplified form that are further described below in the detailed description. This summary is not intended to identify key features or essential features of the claimed subject matter, nor is it intended to be used to limit the scope of the claimed subject matter.

The Third Generation Partnership Project (3GPP) is discussing New Radio (NR) positioning and potential enhancements for reduced capability (RedCap) positioning in which the maximal bandwidth of a RedCap UE is 20 MHz in Frequency Range 1 (FR1) and 100 MHz in Frequency Range 2 (FR2). The potential enhancements include PRS frequency hopping for DL-TDOA, SRS frequency hopping for UL-TDOA, and PRS and SRS frequency hopping for RTT (e.g., multi-RTT).

Certain challenges, however, exist. For instance, because existing DL-TDOA, UL-TDOA and multi-RTT have not supported PRS frequency hopping and SRS frequency hopping for positioning purpose, there is no currently defined mechanism for a UE to provide to a location system sufficient information about the UE's capability for frequency hopping. Further, because it has been assumed that the PRS frequency hopping configuration at the base station is semi-static, there is no support for a location server to indicate to a base station information for achieving a flexible PRS frequency hopping.

In order to overcome one or more of the above issues, various exemplary embodiments of the present disclosure propose a solution for UE positioning using frequency hopping reference signals.

According to a first aspect of the present disclosure, there is provided a method which may be performed by a UE. The method comprises: receiving a capability request message requesting information regarding the UE's positioning capabilities. In accordance with an exemplary embodiment, the method further comprises: transmitting a response message responsive to the capability request message. The response message comprises one or more of: frequency hopping capability information regarding the UE's frequency hopping capability with respect to NR DL-TDOA positioning; frequency hopping capability information regarding the UE's frequency hopping capability with respect to NR UL-TDOA positioning; and frequency hopping capability information regarding the UE's frequency hopping capability with respect to NR RTT (e.g., NR multi-RTT) positioning.

According to a second aspect of the present disclosure, there is provided an apparatus which may be implemented as a UE. The apparatus may comprise one or more processors and one or more memories storing computer program codes. The one or more memories and the computer program codes may be configured to, with the one or more processors, cause the apparatus at least to perform any step of the method according to the first aspect of the present disclosure.

According to a third aspect of the present disclosure, there is provided a computer-readable medium having computer program codes embodied thereon which, when executed on a computer, cause the computer to perform any step of the method according to the first aspect of the present disclosure.

According to a fourth aspect of the present disclosure, there is provided a method which may be performed by a location sever. The method comprises: determining a frequency hopping configuration for use in positioning a UE. In accordance with an exemplary embodiment, the method further comprises: transmitting a configuration message comprising frequency hopping configuration information indicating the determined frequency hopping configuration.

According to a fifth aspect of the present disclosure, there is provided an apparatus which may be implemented as a location server. The apparatus may comprise one or more processors and one or more memories storing computer program codes. The one or more memories and the computer program codes may be configured to, with the one or more processors, cause the apparatus at least to perform any step of the method according to the fourth aspect of the present disclosure.

According to a sixth aspect of the present disclosure, there is provided a computer-readable medium having computer program codes embodied thereon which, when executed on a computer, cause the computer to perform any step of the method according to the fourth aspect of the present disclosure.

According to a seventh aspect of the present disclosure, there is provided a method which may be performed by a location sever. The method comprises: transmitting to a UE a capability request message requesting information regarding the UE's positioning capabilities. In accordance with an exemplary embodiment, the method further comprises: receiving from the UE a response message responsive to the capability request message. The response message comprises one or more of: frequency hopping capability information regarding the UE's frequency hopping capability with respect to NR DL-TDOA positioning; frequency hopping capability information regarding the UE's frequency hopping capability with respect to NR UL-TDOA positioning; and frequency hopping capability information regarding the UE's frequency hopping capability with respect to NR RTT (e.g., NR multi-RTT) positioning.

According to an eighth aspect of the present disclosure, there is provided an apparatus which may be implemented as a location server. The apparatus may comprise one or more processors and one or more memories storing computer program codes. The one or more memories and the computer program codes may be configured to, with the one or more processors, cause the apparatus at least to perform any step of the method according to the seventh aspect of the present disclosure.

According to a ninth aspect of the present disclosure, there is provided a computer-readable medium having computer program codes embodied thereon which, when executed on a computer, cause the computer to perform any step of the method according to the seventh aspect of the present disclosure.

According to a tenth aspect of the present disclosure, there is provided a method which may be performed by a base station. The method comprises: receiving from a location server a PRS configuration request message comprising PRS frequency hopping configuration recommendation information.

According to an eleventh aspect of the present disclosure, there is provided an apparatus which may be implemented as a base station. The apparatus may comprise one or more processors and one or more memories storing computer program codes. The one or more memories and the computer program codes may be configured to, with the one or more processors, cause the apparatus at least to perform any step of the method according to the tenth aspect of the present disclosure.

According to a twelfth aspect of the present disclosure, there is provided a computer-readable medium having computer program codes embodied thereon which, when executed on a computer, cause the computer to perform any step of the method according to the tenth aspect of the present disclosure.

According to a thirteenth aspect of the present disclosure, there is provided a method which may be performed by a base station. The method comprises: receiving from a location server an indication for SRS transmission (Tx) from a target UE. The indication for SRS Tx from the target UE comprises information indicating one or more of: an aggregated bandwidth for SRS frequency hopping; a minimal aggregated bandwidth for SRS frequency hopping; a maximal aggregated bandwidth for SRS frequency hopping; an SRS narrowband bandwidth in SRS frequency hopping; an SRS bandwidth in one bandwidth part (BWP) for SRS frequency hopping; a number of bands for SRS frequency hopping; a number of BWPs for SRS frequency hopping; and a minimal SRS transmission gap at the UE side.

According to a fourteenth aspect of the present disclosure, there is provided an apparatus which may be implemented as a base station. The apparatus may comprise one or more processors and one or more memories storing computer program codes. The one or more memories and the computer program codes may be configured to, with the one or more processors, cause the apparatus at least to perform any step of the method according to the thirteenth aspect of the present disclosure.

According to a fifteenth aspect of the present disclosure, there is provided a computer-readable medium having computer program codes embodied thereon which, when executed on a computer, cause the computer to perform any step of the method according to the thirteenth aspect of the present disclosure.

According to a sixteenth aspect of the present disclosure, there is provided a computer program comprising instructions which when executed by processing circuitry of an apparatus causes the apparatus to perform any of the methods disclosed herein. In one embodiment, there is provided a carrier containing the computer program wherein the carrier is one of an electronic signal, an optical signal, a radio signal, and a computer readable storage medium.

According to a seventeenth aspect of the present disclosure, there is provided an apparatus (e.g., UE, base station, location server) that is configured to perform one or more of the methods disclosed herein. The apparatus may include memory and processing circuitry coupled to the memory.

According to various exemplary embodiments, a UE may be able to inform the UE's capability for frequency hopping with respect to positioning to a location server, so that the location server can provide configuration information for positioning reference signal frequency hopping to a base station. This can achieve frequency hopping for positioning purposes (e.g., PRS frequency hopping for DL-TDOA, SRS frequency hopping for UL-TDOA, PRS and SRS frequency hopping for multi-RTT, etc.) while supporting a flexible frequency hopping configuration in positioning.

### BRIEF DESCRIPTION OF THE DRAWINGS

The accompanying drawings, which are incorporated herein and form part of the specification, illustrate various embodiments.

FIG. 1 illustrates a system according to an embodiment.

FIG. 2 is a message flow diagram illustrating a positioning procedure according to an embodiment.

FIG. 3 is a message flow diagram illustrating a positioning procedure according to an embodiment.

FIG. 4 is a message flow diagram illustrating a positioning procedure according to an embodiment.

FIG. 5 is a flowchart illustrating a process according to an embodiment.

FIG. 6 is a flowchart illustrating a process according to an embodiment.

FIG. 7 is a flowchart illustrating a process according to an embodiment.

FIG. 8 is a flowchart illustrating a process according to an embodiment.

FIG. 9 is a flowchart illustrating a process according to an embodiment.

FIG. 10 is a block diagram of a location server according to an embodiment.

FIG. 11 is a block diagram of a UE according to an embodiment.

FIG. 12 is a block diagram of a base station according to an embodiment.

### DETAILED DESCRIPTION

The embodiments of the present disclosure are described in detail with reference to the accompanying drawings. It should be understood that these embodiments are discussed only for the purpose of enabling those skilled persons in the art to better understand and thus implement the present disclosure, rather than suggesting any limitations on the scope of the present disclosure. Reference throughout this specification to features, advantages, or similar language does not imply that all of the features and advantages that may be realized with the present disclosure should be or are in any single embodiment of the disclosure. Rather, language referring to the features and advantages is understood to mean that a specific feature, advantage, or characteristic described in connection with an embodiment is included in at least one embodiment of the present disclosure. Furthermore, the described features, advantages, and characteristics of the disclosure may be combined in any suitable manner in one or more embodiments. One skilled in the relevant art will recognize that the disclosure may be practiced without one or more of the specific features or advantages of a particular embodiment. In other instances, additional features and advantages may be recognized in certain embodiments that may not be present in all embodiments of the disclosure.

This disclosure describes procedures to support PRS frequency hopping in DL-TDOA, SRS frequency hopping in UL-TDOA, and SRS and PRS frequency hopping in multi-RTT. For example, as described in herein, in some embodiments, a UE may be able to provide to a location server capability information to support PRS frequency hopping in DL-TDOA, SRS frequency hopping in UL-TDOA, and/or SRS and PRS frequency hopping in multi-RTT, thereby enabling the location server to flexibly configure a base station for PRS and/or SRS frequency hopping.

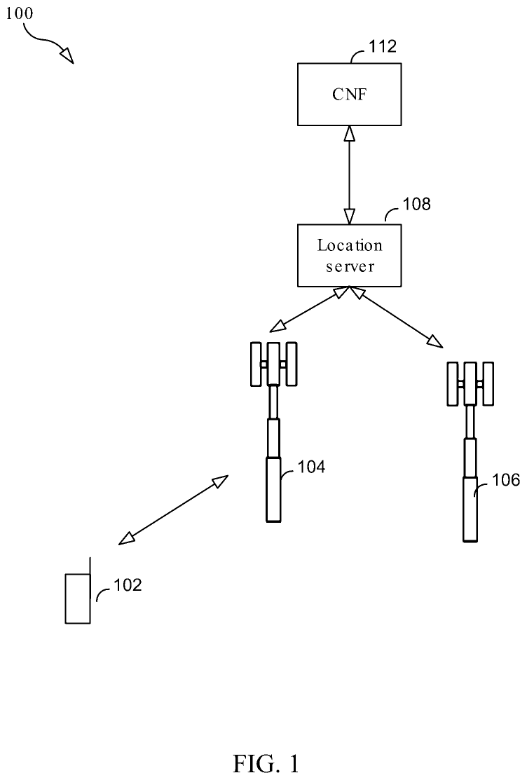

FIG. 1 illustrates a system 100 according to an embodiment. System 100 includes a first base station 104 that is the serving base station for a UE 102 and second base station 106 that is a “neighbor” base station. As used herein, a UE is any device capable of wireless communication with a base station. As used herein, a base station is any device that can receive data wirelessly from a UE and forward the data to another device (e.g., another UE, a server, a control unit, etc.). In some embodiments, a base station comprises a central unit (e.g., gNB-CU) and one or more distributed units (e.g., gNB-DU(s)), which may or may not be co-located with the central unit. System 100 further includes a location server 108 capable of determining the position of the UE (with a least some degree of certainty) using measurement information from the UE 102, the base station 104 and/or the base station 106.

In accordance with exemplary embodiments, the proposed solution according to the present disclosure may be applied for implementing a procedure for positioning a UE using PRS frequency hopping.

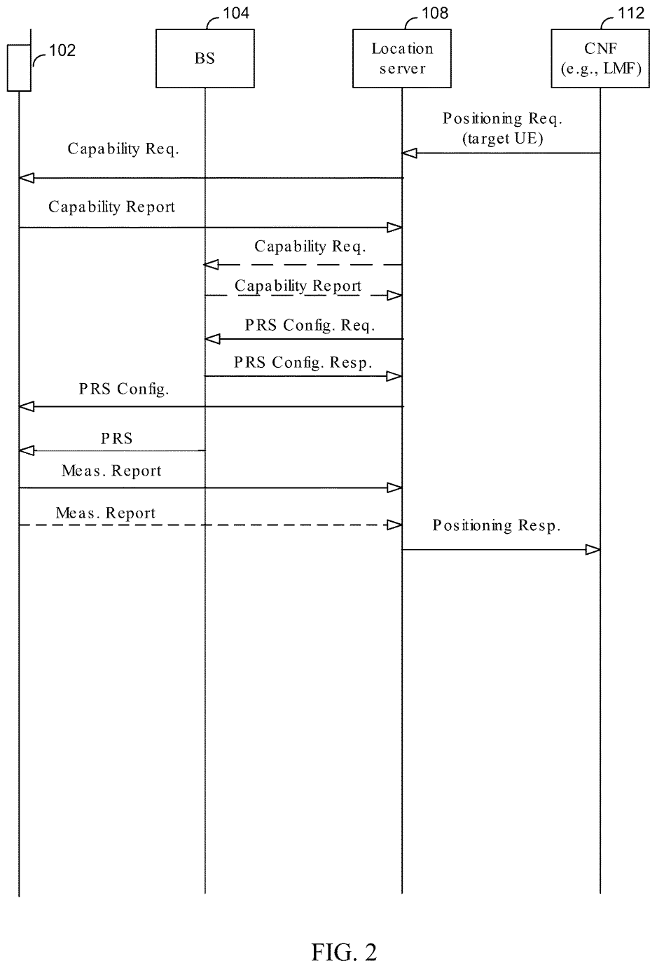

FIG. 2 is a message flow diagram illustrating a procedure for positioning UE 102 using a frequency hopped PRS (i.e., transmitting the PRS using frequency hopping) according to one embodiment.

As shown in FIG. 2, a core network function (CNF) 112 (see also FIG. 1) may send to a location server 108 a positioning request message comprising positioning information for the positioning of at least one target UE (i.e., UE 102). This positioning information may include one or more of: a UE identifier (ID) that identifies UE 102 (i.e., a target UE), UE type information indicating a UE type, UE bandwidth information, information related to positioning requirements.

After receiving the positioning request message, the location server may send to the UE a capability request message. The capability request message may indicate specifically that the location server is requesting the UE's capabilities for DL-TDOA.

The UE may respond to the request by transmitting to the location server a capability report reporting its DL-TDOA capability. In one embodiment, the capability report may include information indicating one or more of:
whether the UE supports PRS frequency hopping measurement,
a maximal supported aggregated bandwidth for PRS frequency hopping measurement,
a maximal supported bandwidth for each PRS narrowband measurement,
a maximal supported bandwidth for PRS measurement,
a maximal supported BWP bandwidth for each PRS measurement,
a maximal number of bands for PRS frequency hopping measurement,
a maximal number of BWPs for PRS frequency hopping measurement, and/or
a minimal PRS measurement gap.

In some embodiments, the location sever may send to the base station 104 a capability request message. The request message may indicate that the location server is requesting the base station PRS frequency hopping capabilities for DL-TDOA positioning. The base station may respond to the capability request message by sending to the location server a capability report indicating at least whether the base station supports flexible PRS frequency hopping configuration.

In some embodiments, the capability request message may be a Transmission/Reception Point (TRP) Information Request message with information of on-demand PRS configuration capability of at least one TRP indicated in the request message. In response to this TRP Information Request, the base station may send to the location server a TRP Information Response message comprising information about whether the base station can support flexible PRS frequency hopping configuration for each TRP indicated in the Request message. In some embodiments, the TRP Information Response message may include on-demand PRS TRP information which is a string with 16 bits. In the on-demand PRS TRP information, each position in the bitmap may represent an on-demand PRS transmission parameter as below:
first bit: Resource Set Periodicity;
second bit: PRS Bandwidth;
third bit: Resource Repetition Factor;
fourth bit: Resource Number of Symbols;
fifth bit: Comb Size;
sixth bit: Number of Frequency Layers;
seventh bit: Start Time and Duration;
eighth bit: Off Indication;
ninth bit: QCL Information;
tenth bit: flexible PRS frequency hopping configuration;
Other bits reserved for future use.

In the example shown, the 10th bit in the string is used to indicate whether the base station can support flexible PRS frequency hopping configuration for each requested TRP.

The location server may send to the base station a PRS configuration request message comprising PRS frequency hopping configuration recommendation information (assuming PRS frequency hopping is supported by both the UE and the base station). The PRS frequency hopping configuration recommendation information may comprise information that indicates one or more of:
an aggregated bandwidth for a PRS frequency hopping,
a minimal aggregated bandwidth for a PRS frequency hopping,
a maximal aggregated bandwidth for a PRS frequency hopping,
a PRS narrowband bandwidth in a PRS frequency hopping,
a PRS bandwidth in one BWP for a PRS frequency hopping,
a number of bands for a PRS frequency hopping,
a number of BWPs for a PRS frequency hopping, and/or
a minimal a PRS transmission gap for a PRS frequency hopping.

The PRS frequency hopping configuration recommendation information may also indicate or include a suggested PRS frequency hopping configuration.

The base station may send a response message back to the location server comprising a PRS frequency hopping configuration or an indication that flexible PRS frequency hopping configuration is not supported. If the response message comprises a PRS frequency hopping configuration, then the PRS frequency hopping configuration included in the response could either be the recommended PRS frequency hopping configuration indicated in the request message from the location server or a PRS frequency hopping configuration derived by the base station using, for example, the PRS frequency hopping configuration recommendation information included in the request message from the location server.

The location server then may send to the UE a PRS frequency hopping configuration for PRS measurement. The PRS frequency hopping configuration sent to the UE could either be the PRS frequency hopping configuration indicated in the request message to the base station or the PRS frequency hopping configuration included in the response message from the base station. The PRS frequency hopping configuration sent to the UE may contain PRS frequency hopping information indicating one or more of:
a bandwidth of narrowband PRS;
a period of narrowband PRS;
a PRS frequency hopping pattern;
a physical resource block (PRB) offset of the first narrowband of narrowband PRS related to start PRB of full PRS bandwidth;
a PRB offset of two most neighboring PRS frequencies in frequency domain;
a duration of narrowband PRS;
a repetition number of narrowband PRS; and
a long period of narrowband PRS.

The base station may transmit a frequency hopped PRS (i.e., transmit PRS in accordance with the PRS frequency hopping configuration). The UE may receive and measure the frequency hopped PRS and transmit a measurement report to report its PRS measurement. The measurement report may be sent to the base station or the location server (if sent to the base station, the base station may forward the report to the location server). The location server may use the measurement report in a process for determining the UE's location. After determining the UE's location, the location server may transmit to the CNF a positioning response message comprising information indicating the target UE and its determined location.

In accordance with exemplary embodiments, the proposed solution according to the present disclosure may be applied for implementing a procedure for SRS frequency hopping configuration.

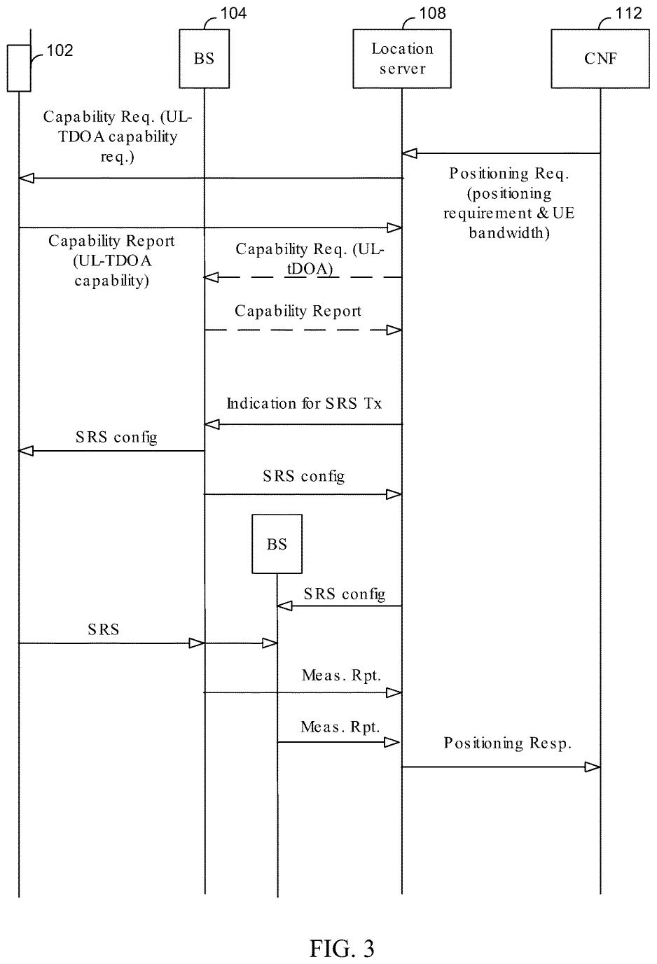

FIG. 3 is a message flow diagram illustrating a procedure for positioning UE 102 using a frequency hopped SRS (i.e., transmitting the SRS using frequency hopping) according to one embodiment.

As shown in FIG. 3, the CNF may send to the location server a positioning request message comprising positioning information for the positioning of at least one UE (i.e., UE 102). This positioning information may include one or more of: a UE identifier (ID) that identifies UE 102, UE type information indicating a UE type, UE bandwidth information, information related to positioning requirements.

After receiving the positioning request message, the location server may send to the UE a capability request message. The capability request message may indicate specifically that the location server is requesting the UE's capabilities for UL-TDOA.

The UE may respond to the request by transmitting to the location server a capability report reporting its UL-TDOA capability. In one embodiment, the capability report may include information indicating one or more of:
whether the UE supports SRS frequency hopping measurement,
a maximal supported aggregated bandwidth for SRS frequency hopping transmission,
a maximal supported bandwidth for each SRS narrowband transmission,
a maximal supported bandwidth for SRS transmission,
a maximal supported BWP bandwidth for each SRS transmission,
a maximal number of bands for SRS frequency hopping transmission,
a maximal number of BWPs for SRS frequency hopping transmission, and
a minimal SRS transmission gap.

In some embodiments, the location sever may send to the base station a capability request message. The request message may indicate that the location server is requesting the base station's SRS frequency hopping capabilities for UL-TDOA positioning. The base station may respond to the capability request message by sending to the location server a capability report indicating at least whether the base station supports flexible SRS frequency hopping configuration.

In some embodiments, the capability request message may be a TRP Information Request message with information of on-demand SRS configuration capability of at least one TRP indicated in the request message. In response to this TRP Information Request, the base station may send to the location server a TRP Information Response message comprising information about whether the base station can support flexible SRS frequency hopping configuration for each TRP indicated in the Request message. In some embodiments, the TRP Information Response message may include on-demand SRS TRP information which is a string with 16 bits. In the on-demand SRS TRP information, each position in the bitmap may represent an on-demand SRS transmission parameter as below:
first bit: Resource Set Periodicity;
second bit: SRS Bandwidth;
third bit: Resource Repetition Factor;
fourth bit: Resource Number of Symbols;
fifth bit: Comb Size;
sixth bit: Number of Frequency Layers;
seventh bit: Start Time and Duration;
eighth bit: Off Indication;
ninth bit: QCL Information;
tenth bit: flexible SRS frequency hopping configuration;
Other bits reserved for future use.

In the example shown, the 10th bit in the string is used to indicate whether the base station can support flexible SRS frequency hopping configuration for each requested TRP.

The location server may send to the serving base station of the target UE an indication for SRS transmission (Tx) from the target UE. This indication for SRS Tx may contain information indicating one or more of:
an aggregated bandwidth for SRS frequency hopping,
a minimal aggregated bandwidth for SRS frequency hopping,
a maximal aggregated bandwidth for SRS frequency hopping,
an SRS narrowband bandwidth in SRS frequency hopping,
an SRS bandwidth in one BWP for SRS frequency hopping,
a number of bands for SRS frequency hopping,
a number of BWPs for SRS frequency hopping, and/or
a minimal SRS transmission gap at the UE side.

The serving base station may determine an SRS configuration based on the information included in the indication for SRS Tx and send to the UE the SRS configuration comprising SRS frequency hopping information and also send the SRS configuration to the location server. The location server may send the SRS configuration containing the SRS frequency hopping information to at least one other base station (e.g., base station 106 as shown in FIG. 3). In one embodiment, the SRS frequency hopping information may comprise information indicating one or more of:
a bandwidth of narrowband SRS,
a period of narrowband SRS,
an SRS frequency hopping pattern,
a PRB offset of the first narrowband of narrowband SRS related to start PRB of full SRS bandwidth,
a PRB offset of two most neighboring SRS frequencies in frequency domain,
a duration of narrowband SRS,
a repetition number of narrowband SRS,
a long period of narrowband SRS.

The UE, after receiving the SRS configuration from the serving base station, may transmit a frequency hopped SRS (i.e., transmit SRS in accordance with the SRS frequency hopping information). The base stations that receive the SRS (e.g., base stations 104 and 106 in this example) and measure the frequency hopped SRS and transmit to the location server a measurement report to report its SRS measurement. The location server may use the measurement report(s) in a process for determining the UE's location. After determining the UE's location, the location server may transmit to the CNF a positioning response message comprising information indicating the target UE and its determined location.

In accordance with exemplary embodiments, the proposed solution according to the present disclosure may be applied for implementing a procedure for frequency hopping in multi-RTT.

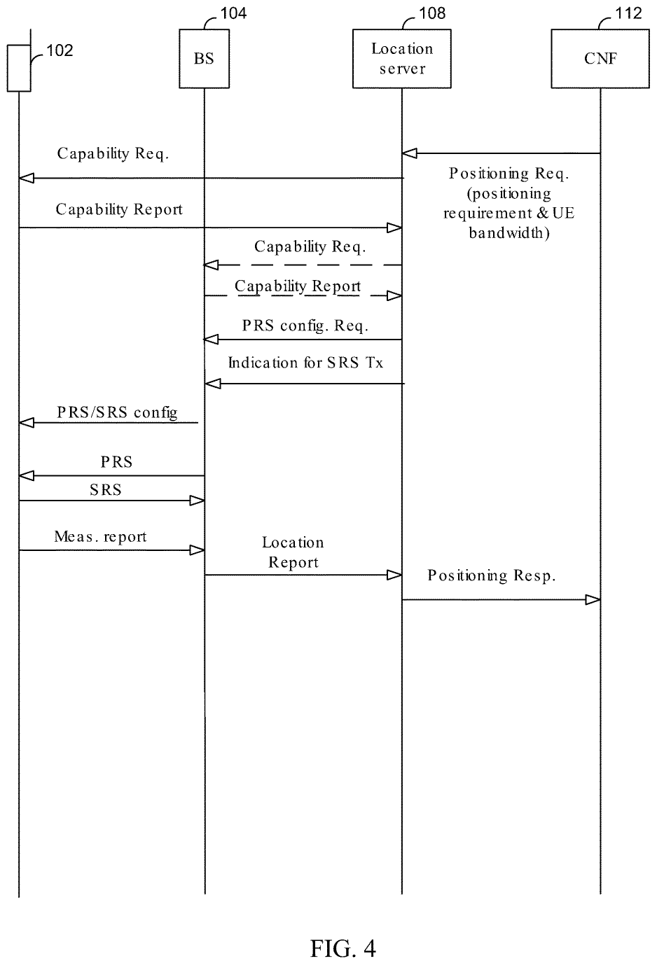

FIG. 4 is a message flow diagram illustrating a procedure for positioning UE 102 using a frequency hopped SRS and/or PRS according to one embodiment.

As shown in FIG. 4, the CNF may send to the location server a positioning request message comprising positioning information for the positioning of at least one UE (i.e., UE 102). This positioning information may include one or more of: a UE identifier (ID) that identifies UE 102, UE type information indicating a UE type, UE bandwidth information, information related to positioning requirements.

After receiving the positioning request message, the location server may send to the UE a capability request message. The capability request message may indicate that the location server is requesting the UE's capabilities for NR RTT positioning.

The UE may respond to the request by transmitting to the location server a capability report reporting its NR RTT capability. In one embodiment, the capability report may include frequency hopping capability information regarding the UE's frequency hopping capability with respect to NR RTT positioning, wherein the information may comprise frequency hopping information indicating one or more of:
a maximal supported aggregated bandwidth for SRS frequency hopping transmission,
a maximal supported bandwidth for each SRS narrowband transmission,
a maximal supported bandwidth for SRS transmission,
a maximal supported BWP bandwidth for each SRS transmission,
a maximal number of bands for SRS frequency hopping transmission,
a maximal number of BWPs for SRS frequency hopping transmission,
a minimal SRS transmission gap,
a maximal supported aggregated bandwidth for PRS frequency hopping measurement,
a maximal supported bandwidth for each PRS narrowband measurement,
a maximal supported bandwidth for PRS measurement,
a maximal supported BWP bandwidth for each PRS measurement,
a maximal number of bands for PRS frequency hopping measurement,
a maximal number of BWPs for PRS frequency hopping measurement,
a minimal PRS measurement gap, and/or
a minimal gap in frequency hopping for PRS measurement and SRS transmission.

In some embodiments, the location sever may send to the base station a capability request message. The request message may indicate that the location server is requesting the base station's NR RTT frequency hopping capabilities. The base station may respond to the capability request message by sending to the location server a capability report indicating at least whether the base station supports flexible SRS frequency hopping configuration and/or flexible PRS frequency hopping configuration. In some embodiments, rather than sending a single capability request message to the base station, the location server may send a capability request message indicating that the location server is requesting the base station's SRS frequency hopping capabilities and send another capability request message indicating that the location server is requesting the base station's PRS frequency hopping capabilities. In such an embodiment, the base station may respond to each request separately (i.e., response to first request indicates at least whether the base station supports flexible SRS frequency hopping configuration and response to second request indicates at least whether the base station supports flexible PRS frequency hopping configuration).

In some embodiments, the capability request message may be a TRP Information Request message with information of on-demand SRS configuration capability and on-demand PRS configuration capability of at least one TRP indicated in the request message. In response to this TRP Information Request, the base station may send to the location server a TRP Information Response message comprising: i) information about whether the base station can support flexible SRS frequency hopping configuration for each TRP indicated in the Request message, and ii) information about whether the base station can support flexible PRS frequency hopping configuration for each TRP indicated in the Request message. Alternatively, rather than sending a single TRP Information Request message requesting both the SRS and PRS configuration capability, the location server can send a first TRP Information Request message requesting the on-demand SRS configuration capability and a second TRP Information Request message requesting the on-demand PRS configuration capability. The base station can respond to each request as described above with respect to the UL-TDOA and DL-TDOA embodiments, respectively.

The location server may send a PRS configuration request for RTT positioning or multi-RTT positioning to at least one base station. The PRS configuration request information may include information indicating one or more of the following:
an aggregated bandwidth for a PRS frequency hopping,
a minimal aggregated bandwidth for PRS frequency hopping,
a maximal aggregated bandwidth for PRS frequency hopping,
a PRS narrowband bandwidth in PRS frequency hopping,
a PRS bandwidth in one BWP for PRS frequency hopping,
a number of bands for PRS frequency hopping,
a number of BWPs for PRS frequency hopping,
a minimal PRS transmission gap for PRS frequency hopping,
a minimal UE measurement gap for PRS frequency hopping,
at least one transmission (transmission/receive) point.

The location server may send an indication for SRS transmission (Tx) from the target UE to the base station. This indication for SRS Tx may contain information indicating one or more of:
an aggregated bandwidth for SRS frequency hopping,
a minimal aggregated bandwidth for SRS frequency hopping,
a maximal aggregated bandwidth for SRS frequency hopping,
an SRS narrowband bandwidth in SRS frequency hopping,
an SRS bandwidth in one BWP for SRS frequency hopping,
a number of bands for SRS frequency hopping,
a number of BWPs for SRS frequency hopping,
a minimal SRS transmission gap at the UE side,
at least one transmission (transmission/receive) point.

The location server may also send to the base station information of the target UE about the minimal gap in frequency hopping for PRS measurement and SRS transmission.

The base station then may send to the UE PRS transmission information and SRS configuration information. The information may include PRS frequency hopping pattern information (described above with respect to the DL-TDOA embodiment) and may include the SRS frequency hopping information (described above with respect to the UL-TDOA embodiment).

The base station then may transmit PRS and the UE may transmit SRS. The base station may measure the time difference of PRS transmission and SRS arriving; the target UE may measure the time difference of SRS transmission and PRS arriving, and moreover send the measurement information to the base station.

The base station may send to the location server a location report comprising information indicating the time difference of PRS transmission and SRS arriving and information indicating the time difference of SRS transmission and PRS arriving. The location report sent by the base station to the location server may also include the frequency hopping information (e.g. PRS frequency hopping information, SRS frequency hopping information, measured total PRS bandwidth, measured total SRS bandwidth).

The above procedure may be repeated with another base station until scanning all needed base stations is completed. After the location server has received a location report from each needed base station, the location sever can send to the CNF the positioning response comprising the information indicating the target UE and its determined location.

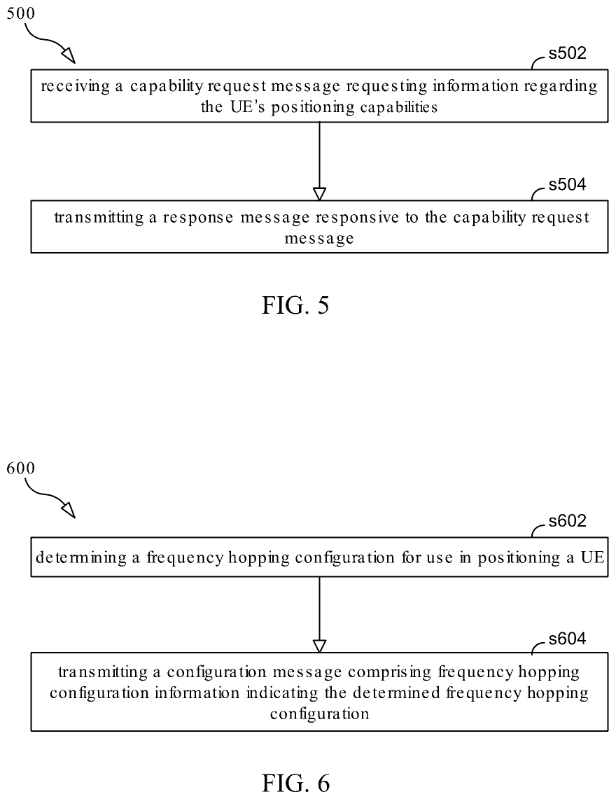

FIG. 5 is a flow chart illustrating a process 500, according to an embodiment. Process 500 may begin in step s502. Step s502 comprises a UE (e.g., a target UE) receiving a capability request message requesting information regarding the UE's positioning capabilities. Step s504 comprises the target UE transmitting a response message responsive to the capability request message. The response message may comprise one or more of: frequency hopping capability information regarding the UE's frequency hopping capability with respect to NR DL-TDOA positioning; frequency hopping capability information regarding the UE's frequency hopping capability with respect to NR UL-TDOA positioning; and/or frequency hopping capability information regarding the UE's frequency hopping capability with respect to NR RTT (e.g., NR multi-RTT), positioning.

FIG. 6 is a flow chart illustrating a process 600, according to an embodiment. Process 600 may begin in step s602. Step s602 comprises a location server determining a frequency hopping configuration for use in positioning a UE. Step s604 comprises the location server transmitting a configuration message comprising frequency hopping configuration information indicating the determined frequency hopping configuration.

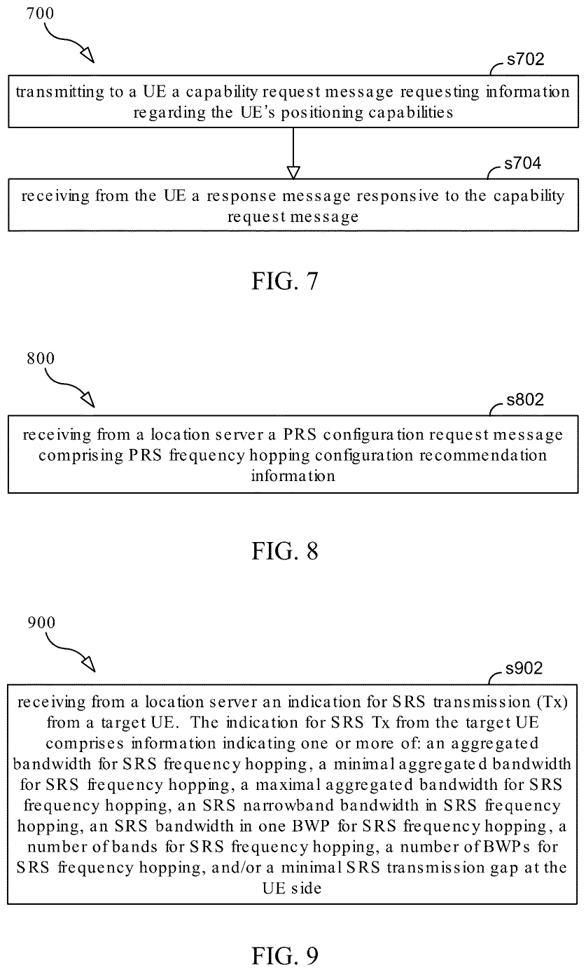

FIG. 7 is a flow chart illustrating a process 700, according to an embodiment. Process 700 may begin in step s702. Step s702 comprises a location server transmitting to a UE a capability request message requesting information regarding the UE's positioning capabilities. Step s704 comprises receiving from the UE a response message responsive to the capability request message. The response message may comprise: frequency hopping capability information regarding the UE's frequency hopping capability with respect to NR DL-TDOA positioning; frequency hopping capability information regarding the UE's frequency hopping capability with respect to NR UL-TDOA positioning; and/or frequency hopping capability information regarding the UE's frequency hopping capability with respect to NR RTT (e.g., NR multi-RTT), positioning.

FIG. 8 is a flow chart illustrating a process 800, according to an embodiment. Process 800 may begin in step s802. Step s802 comprises a base station receiving from a location server a PRS configuration request message comprising PRS frequency hopping configuration recommendation information.

FIG. 9 is a flow chart illustrating a process 900, according to an embodiment. Process 900 may begin in step s902. Step s902 comprises a base station receiving from a location server an indication for SRS transmission (Tx) from a target UE. The indication for SRS Tx from the target UE may comprise information indicating one or more of: an aggregated bandwidth for SRS frequency hopping, a minimal aggregated bandwidth for SRS frequency hopping, a maximal aggregated bandwidth for SRS frequency hopping, an SRS narrowband bandwidth in SRS frequency hopping, an SRS bandwidth in one BWP for SRS frequency hopping, a number of bands for SRS frequency hopping, a number of BWPs for SRS frequency hopping, and/or a minimal SRS transmission gap at the UE side.

An advantage of the embodiments disclosed herein is that they enable a network to configure more suitable PRS signal from network to UE and SRS signal from UE to network to support wideband measurement with narrowband transmission in positioning.

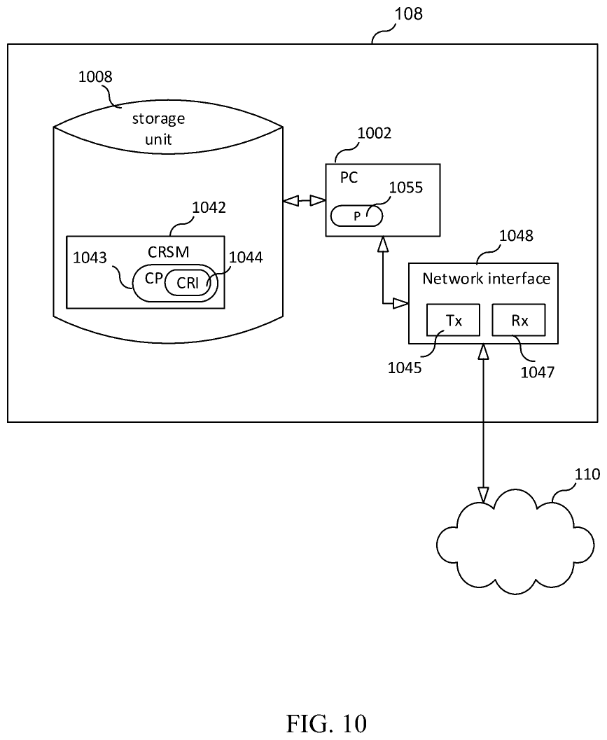

FIG. 10 is a block diagram of a location server 108, according to some embodiments. As shown in FIG. 10, the location server 108 may comprise: processing circuitry (PC) 1002, which may include one or more processors (P) 1055 (e.g., one or more general purpose microprocessors and/or one or more other processors, such as an application specific integrated circuit (ASIC), field-programmable gate arrays (FPGAs), and the like), which processors may be co-located in a single housing or in a single data center or may be geographically distributed (i.e., the location server 108 may be a distributed computing apparatus); at least one network interface 1048 (e.g., a physical interface or air interface) comprising a transmitter (Tx) 1045 and a receiver (Rx) 1047 for enabling the location server 108 to transmit data to and receive data from other nodes connected to a network 110 (e.g., an Internet Protocol (IP) network) to which the network interface 1048 is connected (physically or wirelessly) (e.g., the network interface 1048 may be coupled to an antenna arrangement comprising one or more antennas for enabling the location server 108 to wirelessly transmit/receive data); and a storage unit (a.k.a., “data storage system”) 1008, which may include one or more non-volatile storage devices and/or one or more volatile storage devices. In embodiments where PC 1002 includes a programmable processor, a computer readable storage medium (CRSM) 1042 may be provided. CRSM 1042 may store a computer program (CP) 1043 comprising computer readable instructions (CRI) 1044. CRSM 1042 may be a non-transitory computer readable medium, such as, magnetic media (e.g., a hard disk), optical media, memory devices (e.g., random access memory, flash memory), and the like. In some embodiments, the CRI 1044 of the computer program 1043 is configured such that when executed by PC 1002, the CRI causes the location server 108 to perform steps described herein (e.g., steps described herein with reference to the flow charts). In other embodiments, the location server 108 may be configured to perform steps described herein without the need for code. That is, for example, PC 1002 may consist merely of one or more ASICs. Hence, the features of the embodiments described herein may be implemented in hardware and/or software.

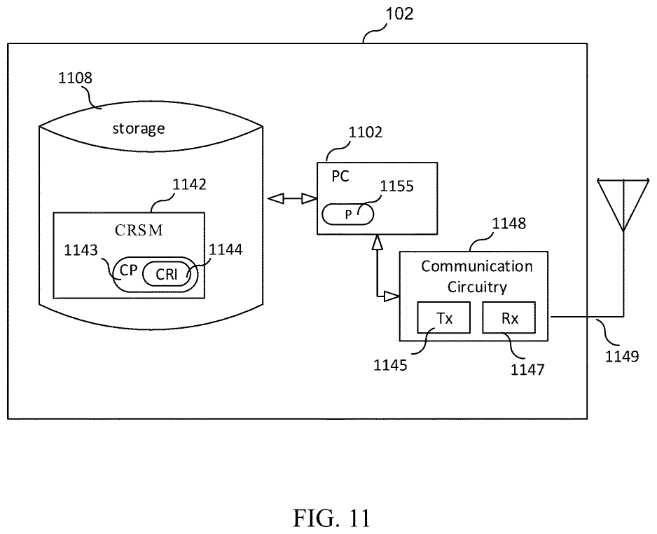

FIG. 11 is a block diagram of a UE 102, according to some embodiments. As shown in FIG. 11, the UE 102 may comprise: processing circuitry (PC) 1102, which may include one or more processors (P) 1155 (e.g., one or more general purpose microprocessors and/or one or more other processors, such as an application specific integrated circuit (ASIC), field-programmable gate arrays (FPGAs), and the like); communication circuitry 1148, which is coupled to an antenna arrangement 1149 comprising one or more antennas and which comprises a transmitter (Tx) 1145 and a receiver (Rx) 1147 for enabling the UE 102 to transmit data and receive data (e.g., wirelessly transmit/receive data); and a storage unit (a.k.a., “data storage system”) 1108, which may include one or more non-volatile storage devices and/or one or more volatile storage devices. In embodiments where PC 1102 includes a programmable processor, a computer readable storage medium (CRSM) 1242 may be provided. CRSM 1242 may store a computer program (CP) 1143 comprising computer readable instructions (CRI) 1144. CRSM 1142 may be a non-transitory computer readable medium, such as, magnetic media (e.g., a hard disk), optical media, memory devices (e.g., random access memory, flash memory), and the like. In some embodiments, the CRI 1144 of computer program 1143 is configured such that when executed by PC 1102, the CRI causes the UE 102 to perform steps described herein (e.g., steps described herein with reference to the flow charts). In other embodiments, the UE 102 may be configured to perform steps described herein without the need for code. That is, for example, PC 1102 may consist merely of one or more ASICs. Hence, the features of the embodiments described herein may be implemented in hardware and/or software.

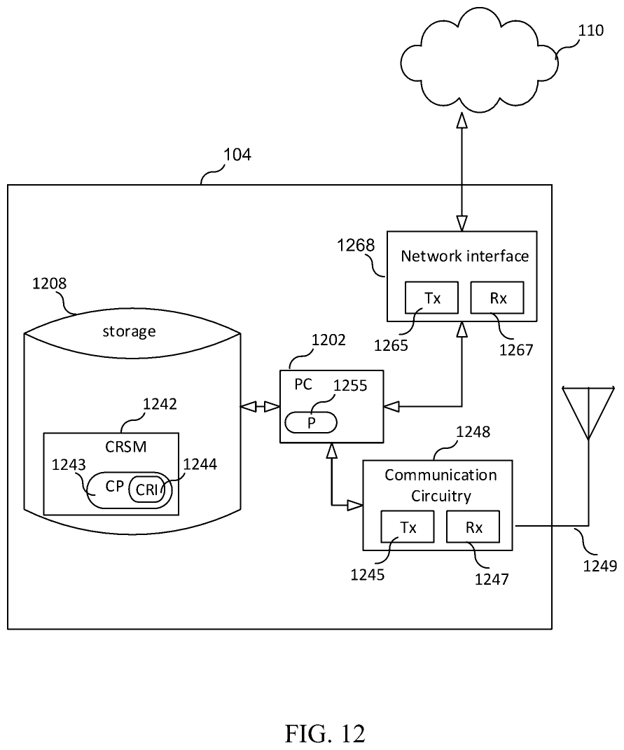

FIG. 12 is a block diagram of a base station 104, according to some embodiments for performing the base station methods disclosed herein. As shown in FIG. 12, the base station 104 may comprise: processing circuitry (PC) 1202, which may include one or more processors (P) 1255 (e.g., a general purpose microprocessor and/or one or more other processors, such as an application specific integrated circuit (ASIC), field-programmable gate arrays (FPGAs), and the like), which processors may be co-located in a single housing or in a single data center or may be geographically distributed (i.e., base station may be a distributed computing apparatus); a network interface 1268 comprising a transmitter (Tx) 1265 and a receiver (Rx) 1267 for enabling the base station 104 to transmit data to and receive data from other nodes connected to a network 110 (e.g., an Internet Protocol (IP) network) to which network interface 1268 is connected; communication circuitry 1248 (e.g., radio transceiver circuitry comprising an Rx 1247 and a Tx 1245) coupled to an antenna system 1249 for wireless communication with UEs or other nodes; and a storage unit (a.k.a., “data storage system”) 1208, which may include one or more non-volatile storage devices and/or one or more volatile storage devices. In embodiments where PC 1202 includes a programmable processor, a computer readable storage medium (CRSM) 1242 may be provided. CRSM 1242 may store a computer program (CP) 1243 comprising computer readable instructions (CRI) 1244. CRSM 1242 may be a non-transitory computer readable medium, such as, magnetic media (e.g., a hard disk), optical media, memory devices (e.g., random access memory, flash memory), and the like. In some embodiments, the CRI 1244 of the computer program 1243 is configured such that when executed by PC 1202, the CRI causes the base station 104 to perform steps described herein (e.g., steps described herein with reference to one or more flow charts). In other embodiments, the base station 104 may be configured to perform steps described herein without the need for code. That is, for example, PC 1202 may consist merely of one or more ASICs. Hence, the features of the embodiments described herein may be implemented in hardware and/or software.

While various embodiments are described herein, it should be understood that they have been presented by way of example only, and not limitation. Thus, the breadth and scope of this disclosure should not be limited by any of the above described exemplary embodiments. Moreover, any combination of the above-described elements in all possible variations thereof is encompassed by the disclosure unless otherwise indicated herein or otherwise clearly contradicted by context.

As used herein transmitting a message “to” or “toward” an intended recipient encompasses transmitting the message directly to the intended recipient or transmitting the message indirectly to the intended recipient (i.e., one or more other nodes are used to relay the message from the source node to the intended recipient). Likewise, as used herein receiving a message “from” a sender encompasses receiving the message directly from the sender or indirectly from the sender (i.e., one or more nodes are used to relay the message from the sender to the receiving node). Further, as used herein “a” means “at least one” or “one or more.”

Additionally, while the processes described above and illustrated in the drawings are shown as a sequence of steps, this was done solely for the sake of illustration. Accordingly, it is contemplated that some steps may be added, some steps may be omitted, the order of the steps may be re-arranged, and some steps may be performed in parallel.

Example embodiments of the techniques and solutions described herein include, but are not limited to, the following enumerated examples:

### UE Embodiments

A1. A method performed by a UE, the method comprising:
receiving a capability request message requesting information regarding the UE's positioning capabilities; and
transmitting a response message responsive to the capability request message, characterized in that the response message comprises one or more of:
frequency hopping capability information regarding the UE's frequency hopping capability with respect to NR DL-TDOA positioning,
frequency hopping capability information regarding the UE's frequency hopping capability with respect to NR UL-TDOA positioning, and/or
frequency hopping capability information regarding the UE's frequency hopping capability with respect to NR RTT (e.g., NR multi-RTT) positioning.

A2. The method of embodiment A1, wherein
the response message comprises the frequency hopping capability information regarding the UE's capability with respect to NR DL-TDOA positioning, and
the frequency hopping capability information regarding the UE's frequency hopping capability with respect to NR DL-TDOA positioning comprises frequency hopping information indicating one or more of:
a maximal supported aggregated bandwidth for PRS frequency hopping measurement,
a maximal supported bandwidth for each PRS narrowband measurement,
a maximal supported bandwidth for PRS measurement,
a maximal supported BWP bandwidth for each PRS measurement,
a maximal number of bands for PRS frequency hopping measurement,
a maximal number of BWPs for PRS frequency hopping measurement, and/or
a minimal PRS measurement gap.

A3. The method of embodiment A1 or A2, wherein
the response message comprises the frequency hopping capability information regarding the UE's frequency hopping capability with respect to NR UL-TDOA positioning, and
the frequency hopping capability information regarding the UE's frequency hopping capability with respect to NR UL-TDOA positioning comprises frequency hopping information indicating one or more of:
a maximal supported aggregated bandwidth for SRS frequency hopping transmission,
a maximal supported bandwidth for each SRS narrowband transmission,
a maximal supported bandwidth for SRS transmission,
a maximal supported BWP bandwidth for each SRS transmission,
a maximal number of bands for SRS frequency hopping transmission,
a maximal number of BWPs for SRS frequency hopping transmission, and/or
a minimal SRS transmission gap.

A4. The method of embodiment A1, A2, or A3, wherein
the response message comprises the frequency hopping capability information regarding the UE's frequency hopping capability with respect to NR RTT positioning, and
the frequency hopping capability information regarding the UE's frequency hopping capability with respect to NR RTT positioning comprises frequency hopping information indicating one or more of:
a maximal supported aggregated bandwidth for SRS frequency hopping transmission,
a maximal supported bandwidth for each SRS narrowband transmission,
a maximal supported bandwidth for SRS transmission,
a maximal supported BWP bandwidth for each SRS transmission,
a maximal number of bands for SRS frequency hopping transmission,
a maximal number of BWPs for SRS frequency hopping transmission,
a minimal SRS transmission gap,
a maximal supported aggregated bandwidth for PRS frequency hopping measurement,
a maximal supported bandwidth for each PRS narrowband measurement,
a maximal supported bandwidth for PRS measurement,
a maximal supported BWP bandwidth for each PRS measurement,
a maximal number of bands for PRS frequency hopping measurement,
a maximal number of BWPs for PRS frequency hopping measurement,
a minimal PRS measurement gap, and/or
a minimal gap in frequency hopping for PRS measurement and SRS transmission.

A5. The method of any one of embodiments A1-A4, further comprising:
receiving a PRS configuration message comprising a PRS frequency hopping configuration.

A6. The method of embodiment A5, wherein the PRS frequency hopping configuration comprises PRS frequency hopping information that indicates one or more of:
a bandwidth of narrowband PRS,
a period of narrowband PRS,
a PRS frequency hopping pattern,
a PRB offset of the first narrowband of narrowband PRS related to start PRB of full PRS bandwidth,
a PRB offset of two most neighboring PRS frequencies in frequency domain,
a duration of narrowband PRS,
a repetition number of narrowband PRS, and/or
a long period of narrowband PRS.

A7. The method of embodiment A5 or A6, further comprising:
receiving a frequency hopped PRS, and
measuring the frequency hopped PRS.

A8. The method of any one of embodiments A1-A7, further comprising:
receiving an SRS configuration message comprising SRS frequency hopping configuration.

A9. The method of embodiment A8, wherein the SRS frequency hopping configuration comprises SRS frequency hopping information that indicates one or more of:
a bandwidth of narrowband SRS,
a period of narrowband SRS,
an SRS frequency hopping pattern,
a PRB offset of the first narrowband of narrowband SRS related to start PRB of full SRS bandwidth,
a PRB offset of two most neighboring SRS frequencies in frequency domain,
a duration of narrowband SRS,
a repetition number of narrowband SRS, and/or
a long period of narrowband SRS.

A10. The method of embodiment A8 or A9, further comprising transmitting a frequency hopped SRS.

### Location Server Embodiments

B1. A method performed by a location server, the method comprising:
determining a frequency hopping configuration for use in positioning a user equipment; and
transmitting a configuration message comprising frequency hopping configuration information indicating the determined frequency hopping configuration.

B2. The method of embodiment B1, wherein the frequency hopping configuration information comprises PRS frequency hopping configuration information that indicates one or more of:
an aggregated bandwidth for a PRS frequency hopping,
a minimal aggregated bandwidth for PRS frequency hopping,
a maximal aggregated bandwidth for PRS frequency hopping,
a PRS narrowband bandwidth in PRS frequency hopping,
a PRS bandwidth in one BWP for PRS frequency hopping,
a number of bands for PRS frequency hopping,
a number of BWPs for PRS frequency hopping,
a minimal PRS transmission gap for PRS frequency hopping, and/or
a minimal UE measurement gap for PRS frequency hopping.

B3. The method of embodiment B1 or B2, wherein the frequency hopping configuration information comprises SRS frequency hopping configuration information that indicates one or more of:
an aggregated bandwidth for SRS frequency hopping,
a minimal aggregated bandwidth for SRS frequency hopping,
a maximal aggregated bandwidth for SRS frequency hopping,
an SRS narrowband bandwidth in SRS frequency hopping,
an SRS bandwidth in one BWP for SRS frequency hopping,
a number of bands for SRS frequency hopping,
a number of BWPs for SRS frequency hopping, and/or
a minimal SRS transmission gap at the UE side.

B4. The method of any one of embodiments B1-B3, wherein transmitting a configuration message comprises transmitting a configuration message to the user equipment.

C1. A method performed by a location server, the method comprising:
transmitting to a UE a capability request message requesting information regarding the UE's positioning capabilities; and
receiving from the UE a response message responsive to the capability request message, characterized in that the response message comprises one or more of:
frequency hopping capability information regarding the UE's frequency hopping capability with respect to NR DL-TDOA positioning,
frequency hopping capability information regarding the UE's frequency hopping capability with respect to NR UL-TDOA positioning, and/or
frequency hopping capability information regarding the UE's frequency hopping capability with respect to NR RTT (e.g., NR multi-RTT) positioning.

C2. The method of embodiment C1, wherein
the response message comprises the frequency hopping capability information regarding the UE's capability with respect to NR DL-TDOA positioning, and
the frequency hopping capability information regarding the UE's frequency hopping capability with respect to NR DL-TDOA positioning comprises frequency hopping information indicating one or more of:
a maximal supported aggregated bandwidth for PRS frequency hopping measurement,
a maximal supported bandwidth for each PRS narrowband measurement,
a maximal supported bandwidth for PRS measurement,
a maximal supported BWP bandwidth for each PRS measurement,
a maximal number of bands for PRS frequency hopping measurement,
a maximal number of BWPs for PRS frequency hopping measurement, and/or
a minimal PRS measurement gap.

C3. The method of embodiment C1 or C2, wherein
the response message comprises the frequency hopping capability information regarding the UE's frequency hopping capability with respect to NR UL-TDOA positioning, and
the frequency hopping capability information regarding the UE's frequency hopping capability with respect to NR UL-TDOA positioning comprises frequency hopping information indicating one or more of:
a maximal supported aggregated bandwidth for SRS frequency hopping transmission,
a maximal supported bandwidth for each SRS narrowband transmission,
a maximal supported bandwidth for SRS transmission,
a maximal supported BWP bandwidth for each SRS transmission,
a maximal number of bands for SRS frequency hopping transmission,
a maximal number of BWPs for SRS frequency hopping transmission, and/or
a minimal SRS transmission gap.

C4. The method of embodiment C1, C2, or C3, wherein
the response message comprises the frequency hopping capability information regarding the UE's frequency hopping capability with respect to NR RTT positioning, and
the frequency hopping capability information regarding the UE's frequency hopping capability with respect to NR RTT positioning comprises frequency hopping information indicating one or more of:
a maximal supported aggregated bandwidth for SRS frequency hopping transmission,
a maximal supported bandwidth for each SRS narrowband transmission,
a maximal supported bandwidth for SRS transmission,
a maximal supported BWP bandwidth for each SRS transmission,
a maximal number of bands for SRS frequency hopping transmission,
a maximal number of BWPs for SRS frequency hopping transmission,
a minimal SRS transmission gap,
a maximal supported aggregated bandwidth for PRS frequency hopping measurement,
a maximal supported bandwidth for each PRS narrowband measurement,
a maximal supported bandwidth for PRS measurement,
a maximal supported BWP bandwidth for each PRS measurement,
a maximal number of bands for PRS frequency hopping measurement,
a maximal number of BWPs for PRS frequency hopping measurement,
a minimal PRS measurement gap, and/or
a minimal gap in frequency hopping for PRS measurement and SRS transmission.

C5. The method of any one of embodiments C1-C4, further comprising
based at least in part on frequency hopping capability information included in the response message from the UE, determining a frequency hopping configuration for use in positioning the UE; and
transmitting a configuration message comprising frequency hopping configuration information indicating the determined frequency hopping configuration.

C6. The method of embodiment C5, wherein the frequency hopping configuration information comprises PRS frequency hopping configuration information that indicates one or more of:
an aggregated bandwidth for a PRS frequency hopping,
a minimal aggregated bandwidth for PRS frequency hopping,
a maximal aggregated bandwidth for PRS frequency hopping,
a PRS narrowband bandwidth in PRS frequency hopping,
a PRS bandwidth in one BWP for PRS frequency hopping,
a number of bands for PRS frequency hopping,
a number of BWPs for PRS frequency hopping,
a minimal PRS transmission gap for PRS frequency hopping, and/or
a minimal UE measurement gap for PRS frequency hopping.

C7. The method of embodiment C5 or C6, wherein the frequency hopping configuration information comprises SRS frequency hopping configuration information that indicates one or more of:
an aggregated bandwidth for SRS frequency hopping,
a minimal aggregated bandwidth for SRS frequency hopping,
a maximal aggregated bandwidth for SRS frequency hopping,
an SRS narrowband bandwidth in SRS frequency hopping,
an SRS bandwidth in one BWP for SRS frequency hopping,
a number of bands for SRS frequency hopping,
a number of BWPs for SRS frequency hopping, and/or
a minimal SRS transmission gap at the UE side.

C8. The method of any one of embodiments C5-C7, wherein transmitting a configuration message comprises transmitting a configuration message to the user equipment.

### Base Station Embodiments

### DL-TDOA

DA1. A method performed by a base station, the method comprising:
receiving from a location server a PRS configuration request message comprising PRS frequency hopping configuration recommendation information.

DA2. The method of embodiment DA1, wherein the PRS frequency hopping configuration recommendation information comprises information that indicates one or more of:
an aggregated bandwidth for a PRS frequency hopping,
a minimal aggregated bandwidth for a PRS frequency hopping,
a maximal aggregated bandwidth for a PRS frequency hopping,
a PRS narrowband bandwidth in a PRS frequency hopping,
a PRS bandwidth in one BWP for a PRS frequency hopping,
a number of bands for a PRS frequency hopping,
a number of BWPs for a PRS frequency hopping, and/or
a minimal a PRS transmission gap for a PRS frequency hopping.

DA3. The method of embodiment DA1 or DA2, further comprising: p1 transmitting to the location server a response message responsive to the PRS configuration request message, the response message comprising a PRS frequency hopping configuration.

DA4. The method of embodiment DA1 or DA2, further comprising:
after receiving the PRS configuration request message, transmitting to the target UE a message comprising a PRS frequency hopping configuration.

DA5. The method of embodiment DA3 or DA4, wherein the PRS frequency hopping configuration comprises PRS frequency hopping information indicating one or more of:
a bandwidth of narrowband PRS,
a period of narrowband PRS,
a PRS frequency hopping pattern,
a PRB offset of the first narrowband of narrowband PRS related to start PRB of full PRS bandwidth,
a PRB offset of two most neighboring PRS frequencies in frequency domain,
a duration of narrowband PRS,
a repetition number of narrowband PRS, and
a long period of narrowband PRS.

### Multi-RTT

DA6. The method of any one of embodiments DA3-DA5, further comprising:
transmitting a PRS according to the PRS frequency hopping configuration;
receiving a SRS transmitted by the target UE;
determining (e.g., measuring) a time difference between the PRS transmission and the receiving of the SRS; and
transmitting to the location server a report message comprising information indicating the determined time difference.

DA7. The method of embodiment DA6, further comprising: prior to receiving the SRS, transmitting to the target UE an SRS frequency hopping configuration for SRS frequency hopping transmission, wherein the SRS transmitted by the UE is transmitted by the UE according to the SRS frequency hopping configuration.

### UL-TDOA

DB1. A method performed by a base station, the method comprising:
receiving from a location server an indication for SRS transmission (Tx) from a target UE, the indication for SRS Tx from the target UE comprises information indicating one or more of:
an aggregated bandwidth for SRS frequency hopping,
a minimal aggregated bandwidth for SRS frequency hopping,
a maximal aggregated bandwidth for SRS frequency hopping,
an SRS narrowband bandwidth in SRS frequency hopping,
an SRS bandwidth in one BWP for SRS frequency hopping,
a number of bands for SRS frequency hopping,
a number of BWPs for SRS frequency hopping, and/or
a minimal SRS transmission gap at the UE side.

DB2. The method of embodiment DB1, further comprising:
after receiving the indication of SRS Tx, transmitting to the target UE an SRS frequency hopping configuration for SRS frequency hopping transmission.

DB3. The method of embodiment DB2, further comprising:
transmitting to the location server said SRS frequency hopping configuration, thereby enabling the location server to provide said SRS frequency hopping configuration to a second base station.

DB4. The method of embodiment DB2 or DB3, wherein the SRS frequency hopping configuration comprises SRS frequency hopping information that indicates one or more of:
a bandwidth of narrowband SRS,
a period of narrowband SRS,
an SRS frequency hopping pattern,
a PRB offset of the first narrowband of narrowband SRS related to start PRB of full SRS bandwidth,
a PRB offset of two most neighboring SRS frequencies in frequency domain,
a duration of narrowband SRS,
a repetition number of narrowband SRS, and/or
a long period of narrowband SRS.

DB5. The method of any one of embodiments DB1-DB4, further comprising measuring a frequency hopped SRS transmitted by the target UE to produce SRS measurement results; and
sending said SRS measurement results to the location server.

### Multi-RTT

DB6. The method of embodiment DB2, further comprising:
receiving an SRS transmitted by the target UE in accordance with SRS frequency hopping configuration;
transmitting to the target UE a PRS;
determining (e.g., measuring) a time difference between the PRS transmission and the receiving of the SRS; and
transmitting to the location server a report message comprising information indicating the determined time difference.

DB7. The method of embodiment DB6, further comprising:
prior to transmitting the PRS, transmitting to the target UE a PRS frequency hopping configuration, wherein the PRS is transmitted by the base station according to the PRS frequency hopping configuration.

E1. A computer program (1043) comprising instructions (1044) which when executed by processing circuitry (1002) of a location server causes the location server to perform the method of any one of embodiments B1-B4 or C1-C8.

E2. A computer program (1143) comprising instructions (1144) which when executed by processing circuitry (1102) of a UE causes the UE to perform the method of any one of embodiments A1-A10.

E3. A computer program (1243) comprising instructions (1244) which when executed by processing circuitry (1202) of a base station causes the base station to perform the method of any one of embodiments DA1-DA7 or DB1-DB7.

E4. A carrier containing the computer program of embodiment E1, E2, or E3 wherein the carrier is one of an electronic signal, an optical signal, a radio signal, and a computer readable storage medium (1042, 1142, 1242).

F1. A UE being configured to perform the method of any one of embodiments A1-A10.

G1. A location server being configured to perform the method of any one of embodiments B1-B4 or C1-C8.

H1. A base station being configured to perform the method of any one of embodiments DA1-DA7 or DB1-DB7.

1. A method performed by a user equipment, UE, the method comprising:
receiving a capability request message requesting information regarding the UE's positioning capabilities; and
transmitting a response message responsive to the capability request message, the response message comprising one or more of:
frequency hopping capability information regarding the UE's frequency hopping capability with respect to new radio downlink time difference of arrival, NR DL-TDOA, positioning;
frequency hopping capability information regarding the UE's frequency hopping capability with respect to NR uplink TDOA, NR UL-TDOA, positioning; and
frequency hopping capability information regarding the UE's frequency hopping capability with respect to NR round-trip-time, NR RTT, positioning.

2. The method according to claim 1, wherein the response message comprises the frequency hopping capability information regarding the UE's capability with respect to NR DL-TDOA positioning, and the frequency hopping capability information regarding the UE's frequency hopping capability with respect to NR DL-TDOA positioning comprises frequency hopping information indicating one or more of:
a maximal supported aggregated bandwidth for positioning reference signal, PRS, frequency hopping measurement;
a maximal supported bandwidth for each PRS narrowband measurement;
a maximal supported bandwidth for PRS measurement;
a maximal supported bandwidth part, BWP, bandwidth for each PRS measurement;
a maximal number of bands for PRS frequency hopping measurement;
a maximal number of BWPs for PRS frequency hopping measurement; and
a minimal PRS measurement gap.

3. The method according to claim 1, wherein the response message comprises the frequency hopping capability information regarding the UE's frequency hopping capability with respect to NR UL-TDOA positioning, and the frequency hopping capability information regarding the UE's frequency hopping capability with respect to NR UL-TDOA positioning comprises frequency hopping information indicating one or more of:
a maximal supported aggregated bandwidth for sounding reference signal, SRS, frequency hopping transmission;
a maximal supported bandwidth for each SRS narrowband transmission;
a maximal supported bandwidth for SRS transmission;
a maximal supported BWP bandwidth for each SRS transmission;
a maximal number of bands for SRS frequency hopping transmission;
a maximal number of BWPs for SRS frequency hopping transmission; and
a minimal SRS transmission gap.

4. The method according to claim 1, wherein the response message comprises the frequency hopping capability information regarding the UE's frequency hopping capability with respect to NR RTT positioning, and the frequency hopping capability information regarding the UE's frequency hopping capability with respect to NR RTT positioning comprises frequency hopping information indicating one or more of:
a maximal supported aggregated bandwidth for SRS frequency hopping transmission;
a maximal supported bandwidth for each SRS narrowband transmission;
a maximal supported bandwidth for SRS transmission;
a maximal supported BWP bandwidth for each SRS transmission;
a maximal number of bands for SRS frequency hopping transmission;
a maximal number of BWPs for SRS frequency hopping transmission;
a minimal SRS transmission gap;
a maximal supported aggregated bandwidth for PRS frequency hopping measurement;
a maximal supported bandwidth for each PRS narrowband measurement;
a maximal supported bandwidth for PRS measurement;
a maximal supported BWP bandwidth for each PRS measurement;
a maximal number of bands for PRS frequency hopping measurement;
a maximal number of BWPs for PRS frequency hopping measurement;
a minimal PRS measurement gap; and
a minimal gap in frequency hopping for PRS measurement and SRS transmission.

5. The method according to claim 1, further comprising:
receiving a PRS configuration message comprising a PRS frequency hopping configuration.

6. The method according to claim 5, wherein the PRS frequency hopping configuration comprises PRS frequency hopping information that indicates one or more of:
a bandwidth of narrowband PRS;
a period of narrowband PRS;
a PRS frequency hopping pattern;
a physical resource block, PRB, offset of a first narrowband of narrowband PRS related to start PRB of full PRS bandwidth;
a PRB offset of two most neighboring PRS frequencies in frequency domain;
a duration of narrowband PRS;
a repetition number of narrowband PRS; and
a long period of narrowband PRS.

7. The method according to claim 5, further comprising:
receiving a frequency hopped PRS; and
measuring the frequency hopped PRS.

8. The method according to claim 1, further comprising:
receiving an SRS configuration message comprising SRS frequency hopping configuration.

9. The method according to claim 8, wherein the SRS frequency hopping configuration comprises SRS frequency hopping information that indicates one or more of:
a bandwidth of narrowband SRS;
a period of narrowband SRS;
an SRS frequency hopping pattern;
a PRB offset of a first narrowband of narrowband SRS related to start PRB of full SRS bandwidth;
a PRB offset of two most neighboring SRS frequencies in frequency domain;
a duration of narrowband SRS;
a repetition number of narrowband SRS; and
a long period of narrowband SRS.

10. The method according to claim 8, further comprising:
transmitting a frequency hopped SRS.

11. A user equipment, UE, comprising:
one or more processors; and
one or more memories comprising computer program codes, the one or more memories and the computer program codes configured to, with the one or more processors, cause the UE at least to:
receive a capability request message requesting information regarding the UE's positioning capabilities; and
transmit a response message responsive to the capability request message, wherein the response message comprises one or more of:
frequency hopping capability information regarding the UE's frequency hopping capability with respect to new radio downlink time difference of arrival, NR DL-TDOA, positioning,
frequency hopping capability information regarding the UE's frequency hopping capability with respect to NR uplink TDOA, NR UL-TDOA, positioning, and
frequency hopping capability information regarding the UE's frequency hopping capability with respect to NR round-trip-time, NR RTT, positioning.

12.-37. (canceled)

38. A method performed by a base station, the method comprising:
receiving from a location server an indication for sounding reference signal, SRS, transmission, Tx, from a user equipment, UE, the indication for SRS Tx from the UE comprises information indicating one or more of:
an aggregated bandwidth for SRS frequency hopping;
a minimal aggregated bandwidth for SRS frequency hopping;
a maximal aggregated bandwidth for SRS frequency hopping;
an SRS narrowband bandwidth in SRS frequency hopping;
an SRS bandwidth in one bandwidth part, BWP, for SRS frequency hopping;
a number of bands for SRS frequency hopping;
a number of BWPs for SRS frequency hopping; and
a minimal SRS transmission gap at the UE side.

39. The method according to claim 38, further comprising:
after receiving the indication of SRS Tx, transmitting to the UE an SRS frequency hopping configuration for SRS frequency hopping transmission.

40. The method according to claim 39, further comprising:
transmitting to the location server the SRS frequency hopping configuration, thereby enabling the location server to provide the SRS frequency hopping configuration to another base station.

41. The method according to claim 39, wherein the SRS frequency hopping configuration comprises SRS frequency hopping information that indicates one or more of:
a bandwidth of narrowband SRS;
a period of narrowband SRS;
an SRS frequency hopping pattern;
a physical resource block, PRB, offset of a first narrowband of narrowband SRS related to start PRB of full SRS bandwidth;
a PRB offset of two most neighboring SRS frequencies in frequency domain;
a duration of narrowband SRS;
a repetition number of narrowband SRS; and
a long period of narrowband SRS.

42. The method according to claim 38, further comprising
measuring a frequency hopped SRS transmitted by the UE to produce SRS measurement results; and
sending the SRS measurement results to the location server.

43. The method according to claim 39, further comprising:
receiving an SRS transmitted by the UE in accordance with the SRS frequency hopping configuration;
transmitting a positioning reference signal, PRS, to the UE;
determining a time difference between the transmission of the PRS and the reception of the SRS; and
transmitting to the location server a report message comprising information indicating the determined time difference.

44. The method according to claim 43, further comprising:
prior to transmitting the PRS, transmitting to the UE a PRS frequency hopping configuration, wherein the PRS is transmitted by the base station according to the PRS frequency hopping configuration.

45.-47. (canceled)
